(19) United States
(12) Patent Application Publication
(10) Pub. No.: US 2024/0219740 A1
(43) Pub. Date: Jul. 4, 2024

(54) DIFFRACTIVE BEAM SPLITTER WITH IMMERSED CONTINUOUS SURFACE AND PREPARATION METHOD THEREOF

(71) Applicant: Jiaxing Uroptics Co., Ltd, Jiaxing (CN)

(72) Inventors: Lei HAO, Shanghai (CN); Qun LUO, Shanghai (CN); Xingpeng YANG, Shanghai (CN)

(73) Assignee: Jiaxing Uroptics Co., Ltd, Jiaxing (CN)

(21) Appl. No.: 18/505,189

(22) Filed: Nov. 9, 2023

(30) Foreign Application Priority Data
Dec. 29, 2022 (CN) 202211707700.5

(51) Int. Cl. G02B 27/10; G02B 1/11

(52) U.S. Cl. CPC G02B 27/1086; G02B 1/11; G02B 27/1073

(57) ABSTRACT

The present disclosure provides a diffractive beam splitter with immersed continuous surface and a preparation method thereof. The diffractive beam splitter includes a single-period structure in array. The single-period structure sequentially includes, from bottom to top, a base structure layer, a first optical medium, and a second optical medium. The refractive indexes of the first optical medium and the second optical medium are different. The surface sagittal height h between the first optical medium and the second optical medium meets the following formula:

$$h = 1 / 2 * λ * Φ * \vert n 1 - n 2 \vert / π .$$

### CROSS REFERENCE TO RELATED APPLICATION(S)

The present application claims the priority of the Chinese patent application No. 202211707700.5 filed on Dec. 29, 2022, the entire content of which is incorporated herein by reference for all purposes.

### TECHNICAL FIELD

The present disclosure relates to the field of optical technology, and in particular relates to a diffractive beam splitter with immersed continuous surface and a preparation method thereof.

### BACKGROUND

A beam splitter may be placed in an optical path for modulating light to achieve the function of proportionally dividing a single beam into multiple target beams. The beam splitter is widely used in fields such as lidar, laser processing, display, and skin treatment.

The beam splitter is a periodic structure, the period of which is affected by parameters such as the angle between adjacent orders and the operating wavelength, and determined by the diffraction equation: d sin θ=mλ, where d is the period, θ is the angle of the diffracted beam, m is the beam order, and λ is the operating wavelength. The surface is continuous in a single period, the specific structure of the surface is affected by the purpose of beam splitting, and the overall surface is in a centrally symmetrical shape.

At present, most diffractive beam splitters are highly discrete stepped structures. Due to the manufacturing reasons, the number of levels is mostly 2\hat{ }n, such as 2-level, 4-level, 8-level, 16-level, etc. Due to limitations of the stepped structure, the diffraction efficiency thereof has a theoretical maximum value. However, factors such as shape and position tolerance introduced during the manufacturing process will further reduce the actual efficiency.

In the field of micro-nano surface processing, single-point diamond machining, mask lithography, maskless laser direct writing, and nano-imprinting are currently the mainly used methods. In addition to the high-cost semiconductor process, accuracies of ultra-precision machining and laser direct writing may reach 100 nm. However, for the sub-micron surface processing, the current accuracy still needs to be improved.

### SUMMARY

The main purpose of the present application is to provide a diffractive beam splitter with immersed continuous surface and a preparation method thereof. The diffractive beam splitter may have benefits such as an overall smooth surface, no stepped structure, an overall diffraction efficiency of more than 95%, an excellent beam splitting uniformity with uniformity error being 5% or less.

In order to achieve the above object, the present disclosure provides the following technical solutions.

A diffractive beam splitter with immersed continuous surface is proposed. The diffractive beam splitter includes at least one single-period structure in array.

The single-period structure sequentially includes, from bottom to top, a base structure layer, a first optical medium, and a second optical medium. The first optical medium and the second optical medium have different refractive indexes.

The surface sagittal height h between the first optical medium and the second optical medium satisfies the following formula:

$$h = 1 / 2 * λ * ϕ * \vert n 1 - n 2 \vert / π ,$$

where λ represents the wavelength; ϕ represents the phase; n1 represents the refractive index of the first optical medium; and n2 represents the refractive index of the second optical medium.

The beam splitter is a periodic structure, the period of which is affected by the angle between adjacent orders and the operating wavelength. The diffraction equation is d sin θ=mλ, where d is the period, θ is the angle of the diffracted beam, m is the beam order, and λ is the operating wavelength.

The conventional diffractive beam splitting scheme utilizes a single modulation surface, the refractive index value of which is fixed as n1. If light is directly incident into air after the medium, the refractive index difference Δn is relatively large, which renders the sagittal height to be relatively low and the processing accuracy of the surface to be difficult to guarantee. If the refractive indexes of media at both sides of the surface is similar, the sagittal height corresponding to the surface is several times higher than the original sagittal height, and the sagittal height corresponding to the surface may be increased generally from a sub-micron value to several microns or even hundreds of microns. The processing difficulty of the surface is thus significantly reduced.

According to a preferred embodiment, the above-mentioned diffractive beam splitter with immersed continuous surface further includes a lower anti-reflection film and an upper anti-reflection film. The lower anti-reflection film covers the lower surface of the base structure layer. The upper anti-reflection film covers the upper surface of the second optical medium.

The operating wavelengths of the lower anti-reflection film and the upper anti-reflection film are the same as the wavelength in the above formula: h=½*

$$h = 1 / 2 * λ * ϕ * \vert n 1 - n 2 \vert / π .$$

By setting the anti-reflection films, the transmittance may be increased. The film may be a single layer of magnesium fluoride (MgF) or other multi-layer film system.

According to a preferred embodiment, in the above-mentioned diffractive beam splitter with immersed continuous surface, the base structure layer is a quartz layer, a glass layer, or an optical plastic layer, and the thickness of the base structure layer is from 2 mm to 3 mm.

According to a preferred embodiment, in the above-mentioned diffractive beam splitter with immersed continuous surface, the first optical medium is optical glass, optical plastic, or optical resin, the refractive index difference between the first optical medium and air is from 0.4 to 1.2, and the thickness of the first optical medium is the surface sagittal height h.

According to a preferred embodiment, in the above-mentioned diffractive beam splitter with immersed continuous surface, the second optical medium is optical glass, optical plastic, or optical resin, and the refractive index difference between the first optical medium and the second optical medium is from 0 to 0.9, and the thickness of the second optical medium is from 20 μm to 30 μm.

According to a preferred embodiment, the above-mentioned diffractive beam splitter with immersed continuous surface further includes an upper base layer, and the upper base layer covers the upper surface of the second optical medium.

The upper base layer is a quartz layer, a glass layer, or an optical plastic layer, and the thickness of the upper base layer is from 2 mm to 3 mm.

By setting the upper base layer, the whole structure may be encapsulated into an integrated structure, and the optical modulation surface is isolated from the external environment. This helps to provide advantages such as better effects of dust prevention, mold proofing, moisture proof, and anti-smoke, thereby maintaining excellent optical properties in a long period.

According to a preferred embodiment, the upper base layer may be attached to the upper surface of the second optical medium by gluing.

In a second aspect of the present application, a preparation method of a diffractive beam splitter with immersed continuous surface is provided, the preparation method comprising the following steps:
(1) manufacturing a master mask, where the surface structure of the master mask matches the surface between the first optical medium and the second optical medium;
(2) providing a viscous first optical medium on the base structure layer, impressing with the master mask to fill the gap between the master mask and the base structure layer with the first optical medium, heating and curing, and removing the master mask; and
(3) providing a viscous second optical medium on a substrate obtained in step (2), impressing with a horizontal master mask, and curing after the surface is flattened to obtain the diffractive beam splitter with immersed continuous surface.

According to a preferred embodiment, during the above-mentioned preparation method of a diffractive beam splitter with immersion continuous surface, in step (1), the surface structure of the master mask is processed by laser direct writing, grayscale photolithography, or ultra-precision machining.

The beneficial effects of the present disclosure are as follows. The diffractive beam splitter with immersed continuous surface described in the present disclosure has an overall smooth surface, no stepped structure, an overall diffraction efficiency more than 95%, a uniformity error between orders less than 5%, so a better beam splitting uniformity.

The sagittal height corresponding to the surface of the diffractive beam splitter with immersed continuous surface according to the present disclosure is several times higher than the original sagittal height, which significantly reduces the processing difficulty of the surface.

### BRIEF DESCRIPTION OF THE DRAWINGS

FIG. 1 is a schematic structural view of a single-period structure of a diffractive beam splitter with immersed continuous surface described in Embodiment 1 of the present application;

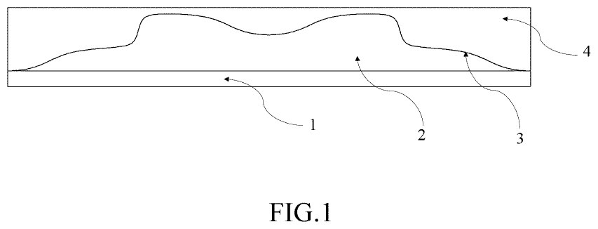

FIG. 2 is a multi-period array diagram of a diffractive beam splitter with immersed continuous surface described in the present application;

FIG. 3 is the simulation diagram of a diffractive beam splitter with immersed continuous surface described in the present application;

FIG. 4 is a simulation diagram of a diffractive optical element with two-dimensional beam splitting as produced by a preparation method of a diffractive beam splitter with immersed continuous surface according to the present application;

FIG. 5 is a simulation diagram of a diffractive optical element with linear beam splitting as produced by a preparation method of a diffractive beam splitter with immersion continuous surface described in the present application;

FIG. 6 is a schematic structural diagram of a single-period structure of a diffractive beam splitter with immersed continuous surface described in Embodiment 4 of the present application;

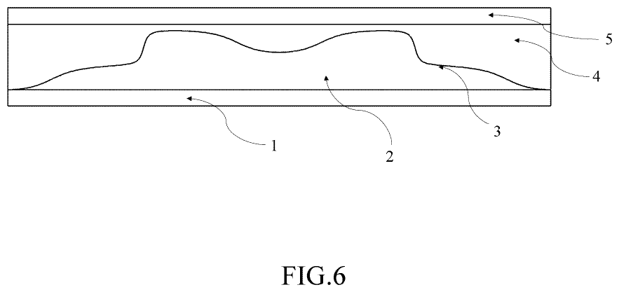

FIG. 7 is a schematic diagram of step (2) in the preparation method of a diffractive beam splitter with immersed continuous surface described in Embodiment 1 of the present application; and

FIG. 8 is a schematic diagram of step (3) in the preparation method of a diffractive beam splitter with immersed continuous surface described in Embodiment 1 of the present application.

In the drawings, 1 indicates the base structure layer; 2 indicates the first optical medium; 3 indicates the beam-splitting surface; 4 indicates the second optical medium; 5 indicates the upper base layer; 6 indicates the master mask, and 7 indicates the horizontal mold plate.

### DETAILED DESCRIPTION OF THE EMBODIMENTS

In order to enable those skilled in the art to better understand the solution of the present application, the technical solution in the embodiments of the present application will be clearly and completely described below in conjunction with specific embodiments. Obviously, the described embodiments are only part of the embodiments of the present application, rather than all the embodiments thereof. Based on the embodiments described in the present application, all other embodiments obtained by those of ordinary skills in the art without creative efforts shall fall within the protection scope of the present application.

The present disclosure provides a diffractive beam splitter with immersed continuous surface. The diffractive beam splitter is a periodic structure and includes at least one single-period structure in array.

The two-dimensional periods (Λx, Λy) of the single-period structure may be obtained according to the number of orders for the design target and the angle between the orders. Upon normal incidence, the following formula is satisfied: Λ*sin(Φ)−n*λ, where Λ is the surface period of the beam splitter, θ is the angle of the diffraction order, n is the diffraction order, and λ is the operating wavelength.

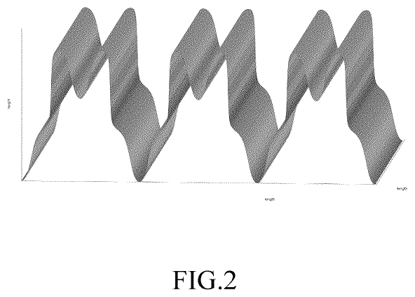

The multi-period array diagram of the diffractive beam splitter with immersed continuous surface described in the present application is shown in FIG. 2.

### Embodiment 1

According to the diffractive beam splitter with immersed continuous surface described in Embodiment 1, the diffractive beam splitter includes a single-period structure in array.

The single-period structure includes sequentially, from bottom to top, a base structure layer (glass layer) with a thickness of 2 mm, a first optical medium (an optical resin layer with a refractive index of 1.7), and a second optical medium (an optical resin layer with a refractive index of 1.5) with a thickness of 20 μm. The refractive indexes of the first optical medium and the second optical medium are different.

A beam-splitting surface is located between the first optical medium and the second optical medium, and the surface sagittal height h thereof satisfies the following formula:

$$h = 1 / 2 * λ * ϕ * \vert n 1 - n 2 \vert / π ,$$

where λ represents the wavelength, with the reference wavelength of 633 nm in the present embodiment; ϕ represents the phase, with the phase range of the present embodiment from 0 to 2π; n1 represents the refractive index of the first optical medium; and n2 represents the refractive index of the second optical medium.

Calculated by the above formula, the surface sagittal height h is in a range from 0 to 4 microns.

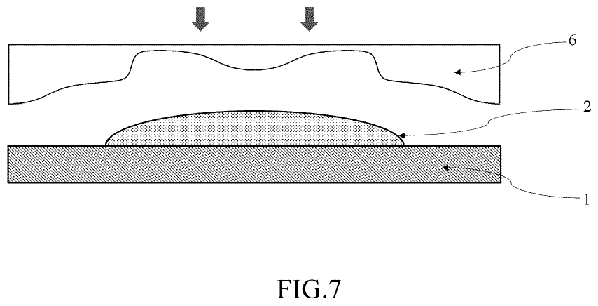

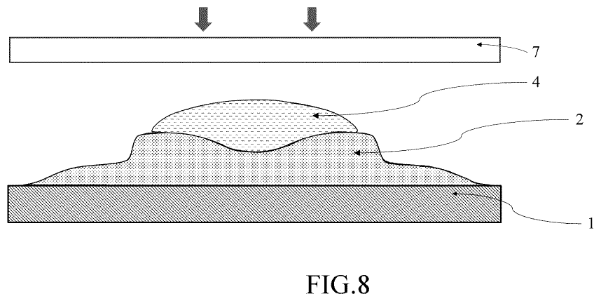

The preparation method of a diffractive beam splitter with immersed continuous surface described in Embodiment 1 comprises the following steps:
(1) manufacturing a master mask by laser direct writing, where the surface structure of the master mask matches the surface between the first optical medium and the second optical medium;
(2) providing a viscous first optical medium on the base structure layer, imprinting with the master mask to fill the gap between the master mask and the base structure layer with the first optical medium, heating and curing, and removing the master mask (as shown in the FIGS. 7); and
(3) providing a viscous second optical medium on a substrate obtained in step (2), imprinting with a horizontal master mask, and curing after the surface is flattened to obtain the diffractive beam splitter with immersed continuous surface (as shown in FIG. 8).

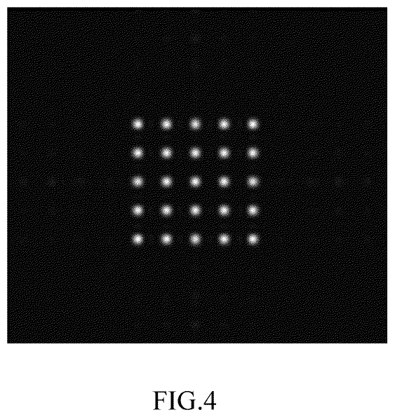

The diffractive beam splitter with immersed continuous surface described in Embodiment 1 is calculated and simulated by a rigorous coupled wave analysis method, the efficiency of each order of the beam splitter may be shown in Table 1, and the simulation diagram is shown in FIG. 4.

TABLE 1

| | | | | | | | | | |
|---|---|---|---|---|---|---|---|---|---|
| Order | 4 | 3 | 2 | 1 | 0 | −1 | −2 | −3 | −4 |
| Diffraction | 0.2% | 22.0% | 0.6% | 23.6% | 0.9% | 23.6% | 0.6% | 22.0% | 0.2% |
| efficiency | | | | | | | | | |

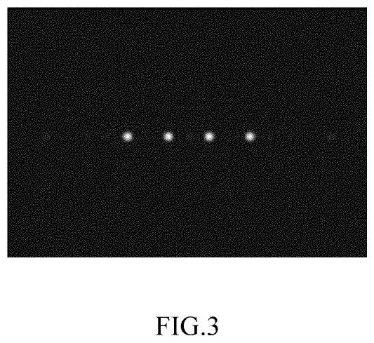

It may be seen from Table 1 and FIG. 3 that the total efficiency of the diffractive beam splitter with continuous surface described in the present application is higher than 90%, and the uniformity error between various orders is less than 5%.

### Embodiment 2

According to the diffractive beam splitter with immersed continuous surface described in Embodiment 2, the diffractive beam splitter includes a single-period structure in array.

The single-period structure sequentially includes, from bottom to top, a base structure layer (glass layer) with a thickness of 2 mm, a first optical medium (an optical resin layer with a refractive index of 1.50), and a second optical medium (an optical resin layer with a refractive index of 1.45) with a thickness of 25 μm. The refractive index of the first optical medium and the refractive index of the second optical medium are different.

The surface sagittal height h between the first optical medium and the second optical medium satisfies the following formula:

$$h = 1 / 2 * λ * ϕ * \vert n 1 - n 2 \vert / π ,$$

where λ represents the wavelength, with the reference wavelength of 633 nm in the present embodiment; ϕ represents the phase, with the phase range of the present embodiment from 0 to 2π; n1 represents the refractive index of the first optical medium; and n2 represents the refractive index of the second optical medium.

Calculated by the above formula, the surface sagittal height h is in a range from 0 to 15 microns.

The preparation method of a diffractive beam splitter with immersed continuous surface described in Embodiment 2 comprises the following steps:
(1) manufacturing a master mask by laser direct writing, where the surface structure of the master mask matches the surface between the first optical medium and the second optical medium;
(2) providing a viscous first optical medium on the base structure layer, imprinting with the master mask to fill the gap between the master mask and the base structure layer with the first optical medium, heating and curing, and removing the master mask; and
(3) providing a viscous second optical medium on a substrate obtained in step (2), imprinting with a horizontal master mask, and curing after the surface is flattened to obtain the diffractive beam splitter with immersed continuous surface.

### Embodiment 3

According to the diffractive beam splitter with immersed continuous surface described in Embodiment 3, the diffractive beam splitter includes a single-period structure in array.

The single-period structure sequentially includes, from bottom to top, a lower anti-reflection film, a base structure layer (glass layer) with a thickness of 2 mm, a first optical medium (an optical resin layer with a refractive index of 1.7), a second optical medium (an optical resin layer with a refractive index of 1.5) with a thickness of 20 μm, and the upper anti-reflection film. The refractive index of the first optical medium and the refractive index of the second optical medium are different.

The surface sagittal height h between the first optical medium and the second optical medium satisfies the following formula:

$$h = 1 / 2 * λ * ϕ * \vert n 1 - n 2 \vert / π ,$$

where λ represents the wavelength, with the reference wavelength of 633 nm in the present embodiment; ϕ represents the phase, with the phase range of the present embodiment from 0 to 2π; n1 represents the refractive index of the first optical medium; and n2 represents the refractive index of the second optical medium.

Calculated by the above formula, the surface sagittal height h is in a range from 0 to 4 microns.

The preparation method of a diffractive beam splitter with immersed continuous surface described in Embodiment 3 comprises the following steps:
(1) manufacturing a master mask by laser direct writing, where the surface structure of the master mask matches the surface between the first optical medium and the second optical medium;
(2) providing a viscous first optical medium on the base structure layer, imprinting with the master mask to fill the gap between the master mask and the base structure layer with the first optical medium, heating and curing, and removing the master mask;
(3) providing a viscous second optical medium on a substrate obtained in step (2), imprinting with a horizontal master mask, and curing after the surface is flattened; and
(4) coating a lower anti-reflection film on the lower surface of the base structure layer and an upper anti-reflection film on the upper surface of the second optical medium respectively to obtain the diffractive beam splitter with immersed continuous surface.

### Embodiment 4

According to the diffractive beam splitter with immersed continuous surface described in Embodiment 4, the diffractive beam splitter includes a single-period structure in array.

The single-period structure sequentially includes, from bottom to top, a base structure layer (glass layer) with a thickness of 2 mm, a first optical medium (an optical resin layer with a refractive index of 1.50), a second optical medium (an optical resin layer with a refractive index of 1.45) with a thickness of 30 μm, and an upper base layer (optical plastic layer) with a thickness of 2 mm. The refractive index of the first optical medium and the refractive index of the second optical medium are different.

The surface sagittal height h between the first optical medium and the second optical medium satisfies the following formula:

$$h = 1 / 2 * λ * ϕ * \vert n 1 - n 2 \vert / π ,$$

where λ represents the wavelength, with the reference wavelength of 633 nm in the present embodiment; ϕ represents the phase, with the phase range of the present embodiment from 0 to 2π; n1 represents the refractive index of the first optical medium; and n2 represents the refractive index of the second optical medium.

Calculated by the above formula, the surface sagittal height h is in a range from 0 to 15 microns.

The preparation method of a diffractive beam splitter with immersed continuous surface described in Embodiment 4 comprises the following steps:
(1) manufacturing a master mask by laser direct writing, where the surface structure of the master mask matches the surface between the first optical medium and the second optical medium;
(2) providing a viscous first optical medium on the base structure layer, imprinting with the master mask to fill the gap between the master mask and the base structure layer with the first optical medium, heating and curing, and removing the master mask;
(3) providing a viscous second optical medium on a substrate obtained in step (2), imprinting with a horizontal master mask, and curing after the surface is flattened; and
(4) adhering an upper base layer on the upper surface of the second optical medium to obtain the diffractive beam splitter with immersed continuous surface.

The preparation method of a diffractive beam splitter with immersed continuous surface described in the present application may also produce diffractive optical elements with different optical effects such as two-dimensional beam splitting, linear beam splitting, and special patterns.

The simulation diagram of the obtained diffractive optical element with two-dimensional beam splitting is shown in FIG. 4.

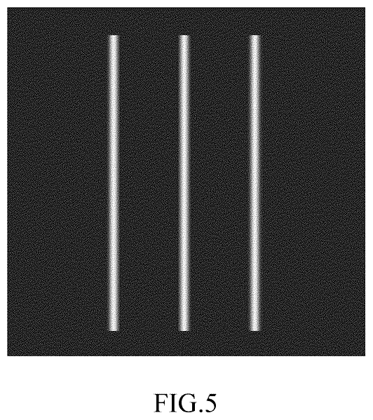

The simulation diagram of the obtained diffractive optical element with linear beam splitting is shown in FIG. 5.

Apart from the base structure layer 1, the first optical medium 2, and the second optical medium 4, the horizontal mold plate 7 is also shown in FIG. 8 of the present disclosure. The horizontal mold plate 7 may be used for squeezing the first optical medium 2, such as optical adhesive, such that a flat and horizontal upper surface is obtained.

The above is only preferred embodiments of the present disclosure. It should be noted that for those of ordinary skills in the art, without departing from the method of the present disclosure, some improvements and supplements may also be made, and these improvements and supplements shall also be considered as falling within the protection scope of the present disclosure.

1. A diffractive beam splitter with immersed continuous surface, wherein
the diffractive beam splitter includes at least one single-period structure in array;
the single-period structure includes a base structure layer, a first optical medium, and a second optical medium sequentially from bottom to top, the first optical medium and the second optical medium having different refractive indexes; and
a surface sagittal height h between the first optical medium and the second optical medium satisfies a formula of:
$$h = 1 / 2 * λ * ϕ * \vert n 1 - n 2 \vert / π ,$$
where λ represents a wavelength, ϕ represents a phase, n1 represents a refractive index of the first optical medium, and n2 represents a refractive index of the second optical medium.

2. The diffractive beam splitter with immersed continuous surface according to claim 1, further comprising: a lower anti-reflection film and an upper anti-reflection film, wherein
the lower anti-reflection film covers a lower surface of the base structure layer, and the upper anti-reflection film covers an upper surface of the second optical medium.

3. The diffractive beam splitter with immersed continuous surface according to claim 1, wherein
the base structure layer is a quartz layer, a glass layer, or an optical plastic layer, and
a thickness of the base structure layer is about 2 mm or 3 mm.

4. The diffractive beam splitter with immersed continuous surface according to claim 1, wherein
the first optical medium is optical glass, optical plastic, or optical resin, and
a refractive index difference between the first optical medium and air is from 0.4 to 1.2.

5. The diffractive beam splitter with immersed continuous surface according to claim 4, wherein
the second optical medium is optical glass, optical plastic, or optical resin,
a refractive index difference between the first optical medium and the second optical medium is from 0 to 0.9, and
a thickness of the second optical medium is from 20 μm to 30 μm.

6. The diffractive beam splitter with immersed continuous surface according to claim 1, further comprising: an upper base layer, wherein
the upper base layer covers an upper surface of the second optical medium,
the upper base layer is a quartz layer, a glass layer, or an optical plastic layer, and
a thickness of the upper base layer is from 2 mm to 3 mm.

7. A preparation method of the diffractive beam splitter with immersed continuous surface according to claim 1, comprising steps of:
(1) manufacturing a master mask, wherein a surface structure of the master mask matches a surface between the first optical medium and the second optical medium;
(2) providing the viscous first optical medium on the base structure layer, impressing with the master mask to fill a gap between the master mask and the base structure layer with the first optical medium, heating and curing, and removing the master mask; and
(3) providing the viscous second optical medium on a substrate obtained in step (2), impressing with a horizontal master mask, and curing after the surface is flattened to obtain the diffractive beam splitter with immersed continuous surface.

8. The preparation method of the diffractive beam splitter with immersed continuous surface according to claim 7, wherein
in step (1), the surface structure of the master mask is processed by laser direct writing, grayscale photolithography, or ultra-precision machining.
